(19) United States
(12) Patent Application Publication
(10) Pub. No.: US 2023/0315953 A1
(43) Pub. Date: Oct. 5, 2023

(54) USING DEEP REINFORCEMENT LEARNING FOR TIME CONSTRAINT MANAGEMENT AT A MANUFACTURING SYSTEM

(71) Applicant: Applied Materials, Inc., Santa Clara, CA (US)

(72) Inventors: Harel Yedidsion, Pflugerville, TX (US); Prafulla Dawadi, San Mateo, CA (US); David Everton Norman, Bountiful, UT (US)

(21) Appl. No.: 18/130,491

(22) Filed: Apr. 4, 2023

Related U.S. Application Data
(60) Provisional application No. 63/327,763, filed on Apr. 5, 2022.

(51) Int. Cl. G06F 30/27

(52) U.S. Cl. CPC G06F 30/27; G06F 2111/04

(57) ABSTRACT

A method for training an agent for a substrate manufacturing system is provided. The method includes initializing an agent of a predictive subsystem of a substrate manufacturing system to select an action to perform in a simulation environment associated with the substrate manufacturing system and initiating a simulation of the selected action in the simulation environment. In response to pausing the simulation, the method further includes obtaining, based on an environment state associated with the simulation, output data and updating the agent, based on the output data, to be configured to generate one or more dispatching decisions indicative of a time to initiate processing of one or more substates in the substrate manufacturing system.

### RELATED APPLICATION

This application claims the benefit of U.S. Provisional Application No. 63/327,763, filed Apr. 5, 2022, the entire content of which is hereby incorporated by reference.

### TECHNICAL FIELD

The present disclosure relates to methods and mechanisms for using deep reinforcement learning for time constraint management at a manufacturing system.

### BACKGROUND

Before a substrate becomes a finished product (e.g., a wafer, an electronic device, etc.), the substrate can be processed according to a set of operations each performed at a tool of a manufacturing system. In some instances, one or more operations can be subject to a time constraint. A time constraint refers to a particular amount of time after an operation is completed that a subsequent operation is to be completed. For example, a substrate can be processed according to a first operation where a first material is deposited on a surface of the substrate and a second operation where a second material is deposited on the first material. The first operation and the second operation can be subject to a time constraint where the second material is to be deposited on the first material within a particular amount of time, otherwise the first material can begin to degrade and the substrate cannot be used to produce a finished product (i.e., becomes unusable). A time constraint window refers to a particular amount of time to complete an operation that prompts a time constraint (referred to as an initiating operation) and the amount of time after the initiating operation is completed that a subsequent operation (referred to a completion operation) is to be completed. In some instances, one or more operations can be performed between the initiating operation and the completion operation.

In most instances, an operation cannot be started for a substrate when the substrate arrives at the tool, as the tool can be processing other substrates. As such, an operator of the manufacturing system (e.g., an industrial engineer, a process engineer a system engineer, etc.) schedules operations to run at particular times in order to satisfy a time constraint associated with the operation. For example, an operator can delay an operation from being performed for a substrate until each tool set to perform an operation associated with a time constraint has capacity to perform the operation within the time constraint window.

In some instances, a completion operation for a first time constraint window can also be an initiating operation for a second time constraint window. In such instances, an operator of a manufacturing system can schedule an initiating operation for the first time constraint window to start at a particular time to satisfy a first time constraint of the first time constraint window and a second time constraint of the second time constraint window. In other instances, an operation can be a completion operation for both a first time constraint window and a second time constraint window. In such instances, an operator can schedule initiating operations for the first time constraint window and the second time constraint window to start at a particular time to satisfy a first time constraint of the first time constraint window and a second time constraint of the second time constraint window.

As manufacturing systems become more complex, more operations are subject to time constraints. In order to schedule a substrate to be started at an initiating operation, an operator (e.g., using a computing system) accounts for all time constraints that could be prompted by the initiating operation. To account for all time constraints that could be prompted by the initiating operation, the operator accounts for a capacity of each tool that can perform the initiating operation, the completion operation, and each operation in between. In some instances, a time constraint window including the initiating operation can correspond to a significant amount of time (e.g., 6 hours, 8 hours, 12 hours, 24 hours, etc.). The operator can have difficulty in accounting for each time constraint and capacities for each tool of the manufacturing system for a significant amount of time into the future. For some computing systems, this accounting can be classified as a NP-hard (non-deterministic polynomial-time hard) problem. As such, the operator can be unsuccessful in scheduling a substrate to be started at each initiating operation of the set of operations so that each time constraint can be satisfied. As a result, the substrate can violate a time constraint of the set of operations and become unusable. Each substrate that becomes unusable can reduce overall system throughput and contribute to increasing overall system latency.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method for training a software agent is provided. The method includes initializing a software agent to select an action to perform in a simulation environment associated with a manufacturing system and initiating a simulation of the selected action in the simulation environment. In response to pausing the simulation, the method further includes obtaining, based on an environment state associated with the simulation, output data and updating the software agent, based on the output data, to be configured to generate one or more dispatching decisions indicative of a time to initiate processing of one or more substates in the manufacturing system.

In another aspect of the disclosure, a method for time constraint management at a manufacturing system is provided. The method includes receiving a request to initiate a set of operations to be run one a candidate set of substrates at a manufacturing system, wherein the set of operations comprises one or more operations that each have one or more time constraints. The method further includes obtaining current data relating to a current state of the manufacturing system and applying a software agent to the current data to determine a time to process the candidate set of substrates. The method further includes initiating the set of operations on the candidate set of substrates at the determined time.

A further aspect of the disclosure includes an electronic device manufacturing system comprising a memory device and a processing device, operatively coupled to the memory device, to perform operations according to any aspect or implementation described herein.

A further aspect of the disclosure includes a non-transitory computer-readable storage medium comprising instructions that, when executed by a processing device operatively coupled to a memory, performs operations according to any aspect or implementation described herein.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain implementations.

FIG. 2 illustrates an example system for performing reinforcement learning to generate a software agent, according to certain implementations.

FIG. 3 is a flow diagram of a method for training a software agent, according to certain implementations.

FIG. 4 is a top schematic view of an example manufacturing system, according to certain implementations.

FIG. 5 illustrates a set of operations subject to one or more time constraints, in accordance with implementations of the present disclosure.

FIG. 6 is a flow diagram showing a method of initiating a set of operations based on the dispatching decisions generated using a machine-learning model, according to certain implementations.

FIG. 7 is a block diagram illustrating a computer system, according to certain implementations.

### DETAILED DESCRIPTION

Described herein are technologies directed to using reinforcement learning for time constraint management at a manufacturing system. In some processes, a series of operations can be performed at various stages of the manufacturing system. For example, a series of operations can be performed to deposit a coating (or multiple coatings) on a surface of a substrate and etch a three-dimensional pattern into the coating. In some instances, one or more of the series of operations can be subject to a time constraint. A time constraint can refer to a limitation or protocol in which, after an operation is performed at the manufacturing system, a subsequent operation is to be completed within a particular amount of time. For example, the manufacturing system can be subject to a time constraint where the etch process is to be performed for the substrate within a particular number of hours (e.g., 12 hours) after the coating is deposited on the surface of a substrate. If the time constraint is not satisfied (e.g., if the etch process is not performed within the particular number of hours), the substrate can become defective and unusable.

Implementations of the present disclosure are directed to using deep reinforcement learning for managing time constraints at a substrate manufacturing system. A processing device, can receive a request to initiate operations to be run at a manufacturing system, where one or more operations are subject to a time constraint. The processing device can determine, in view of the time constraints, when to release a number of substrates for processing such that they can be successfully processed at the manufacturing system within a particular time period. For example, the processing device can identify a time that a set of candidate substrates at the substrate manufacturing system are to be processed during the set of operations.

To identify a set of candidate substrates, the processing device can obtain data relating to the current state of manufacturing equipment. The data can include current state data, sensor data, contextual data, task data, etc. For example, the current data can relate to one or more operations being performed on one or more substrates being processed, a number of substrates being processed at the manufacturing equipment at a particular instance of time, a number of substrates in a manufacturing equipment queue, current service life, setup data, a set of operations that include individual processes performed at one or more manufacturing facilities of a production environment, sensor data, etc. The processing device can provide the data relating to the current state of manufacturing equipment as input to an agent. An agent can include a software program that perceives its environment, takes action autonomously in order to achieve one or more goals, and can improve its performance with learning.

The agent (also referred to herein as a software or intelligent agent) can be used to generate dispatching decisions. A dispatching decision can decide what action should be performed at a given time in the production environment. Examples of dispatching decisions can include, and are not limited to, where a substrate should be processed next in the production environment, which substrate should be picked for an idle piece of equipment in the production environment, and so forth. Based on the dispatching decisions data, the processing device can initiate the set of operations on the candidate set of substrates at a particular time

In some implementations, the dispatching decision can indicate at which time to process a set of candidate substrates (e.g., when to schedule a substrate to be started at an initiating operation). In other implementations, dispatching decisions can involve decisions such as whether to start processing a batch that has fewer substrates than allowed, or wait to start the batch until additional substrates are available so a full batch can be started. In yet other implementations, dispatching decisions can involve deciding to release substrates that are waiting at a logical gate step so they are available to be dispatched to process at a subsequent processing step. In some instances, to manage time constraints, the process flow will include non-processing (logical) steps before a step that starts a time constraint (referred to as gate steps). The lots (sets of substrates) wait at the gate step until the system determines that there is capacity for them to fully process. When there is capacity, they are released from the gate step and are available to process at the first operation in the time constraint. The software agent can control this gate step.

In some implementations, the software agent can be trained using deep reinforcement learning. Deep reinforcement learning combines artificial neural networks with a framework of reinforcement learning that helps software agents learn how to reach their goals (e.g., deep reinforcement learning includes learning from existing knowledge and applying it to a new data set). In one example, during training, the software agent selects and simulates an action (in a simulation environment) one timestep into the future. The software agent then receives a new environment state, and a reward. The state-action-reward sequence is saved, and periodically, the reinforcement learning algorithm uses this experience to update the weights of the neural network which represents a policy. The policy is used to pick the next action. The policy updates aim to maximize the cumulative reward over the time horizon. Once the learning curve stabilizes and the policy stops improving, the policy is saved and can be used on current data related to the manufacturing equipment.

Aspects and implementations of the present disclosure address the shortcomings of the existing technology by providing techniques for scheduling a substrate or a set of substrates to be started at an initiating operation. A processing device can use a trained software agent to determine a set of candidate substrates for processing during a current or future period of time (based on a set of operations). By applying the software agent, the processing device can obtain a dispatching decision indicative of when to schedule a set of substrates for processing. By determining when to schedule the set of substrates, the processing device can schedule the set of substates to be initiated at the set of operations within the time period so that few or no substrates violate a time constraint for the set of operations. As a result, a small number of substrates, or approximately zero substrates, will violate a time constraint of the set of operations, resulting in a significant number of substrates processed at the manufacturing system containing no or few defects. As such, the trained software agent can reduce queue time violations while maintaining high throughput, as opposed to convention heuristic solution which can reduce throughput.

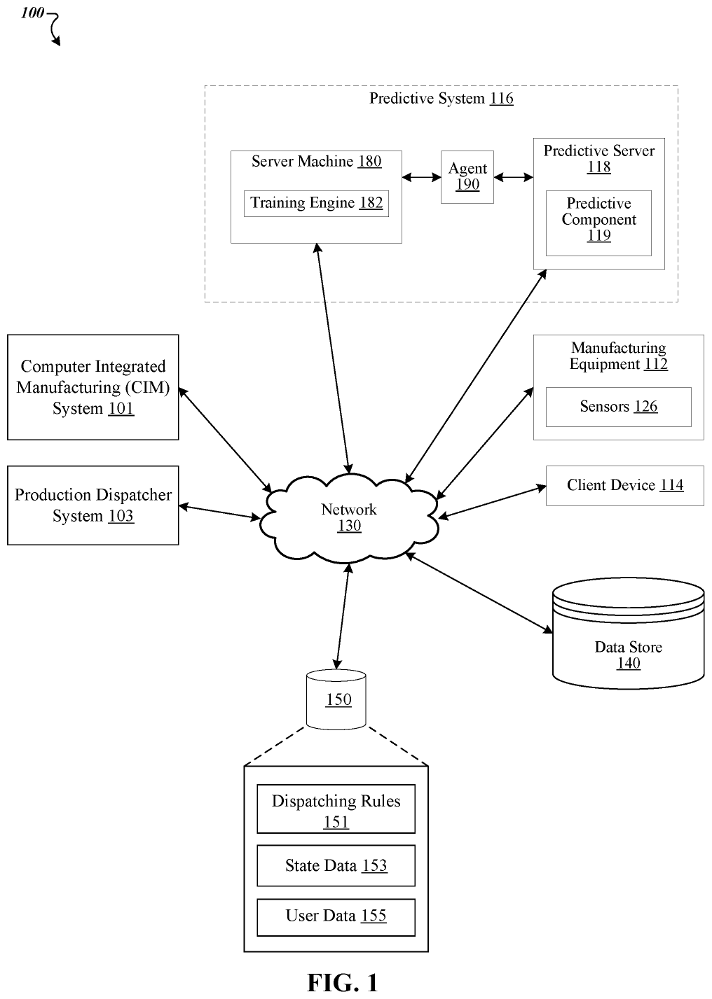

FIG. 1 is a block diagram illustrating a production environment 100, according to aspects of the present disclosure. A production environment 100 can include multiple systems, such as, and not limited to, a production dispatcher system 103, manufacturing equipment 112 (e.g., manufacturing tools, automated devices, etc.), a client device 114, a predictive system 116 (e.g., to generate predictive data such as dispatching decisions, to provide model or agent adaptation, to use a knowledge base, etc.) and one or more computer integrated manufacturing (CIM) systems 101. Examples of a production environment 100 can include, and are not limited to, a manufacturing plant, a fulfillment center, etc. For brevity and simplicity, a manufacturing system is used as an example of a production environment 100 throughout this description.

In some implementations, production environment 100 can be a semiconductor manufacturing environment. In such implementations, manufacturing equipment 112 can perform multiple different operations related to the fabrication of semiconductor substrates. For example, manufacturing equipment 112 can perform cutting operations, cleaning operations, deposition operations, etching operations, testing operations, and so forth. Aspects of the present disclosure are described with regard to fabrication of semiconductor substrates in a semiconductor manufacturing environment. However, it should be noted that implementations of the present disclosure can be applied to other production environments 100 configured to fabricate or otherwise process lots different from semiconductor substrates. A lot can refer to a set of substrates.

The manufacturing equipment 112 can include sensors 126 configured to capture data for a substrate being processed at the manufacturing equipment 112. In some implementations, the manufacturing equipment 112 and sensors 126 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some implementations, manufacturing equipment 112 can include, or be operationally coupled to, metrology equipment that includes a metrology server (e.g., a metrology database, metrology folders, etc.) and metrology identifier reader (e.g., FOUP RFID reader for metrology system).

Manufacturing equipment 112 can produce products, such as electronic devices, following a recipe or performing runs over a period of time. Manufacturing equipment 112 can include a process chamber. Manufacturing equipment 112 can perform a process for a substrate (e.g., a wafer, etc.) at the process chamber. Examples of substrate processes include a deposition process to deposit one or more layers of film on a surface of the substrate, an etch process to form a pattern on the surface of the substrate, etc. Manufacturing equipment 122 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

In some implementations, sensors 126 provide sensor data (e.g., sensor values, features, trace data) associated with manufacturing equipment 112 (e.g., associated with producing, by manufacturing equipment 112, corresponding products, such as wafers). The manufacturing equipment 112 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 112. The sensor data can be provided while the manufacturing equipment 112 is performing manufacturing processes (e.g., equipment readings when processing products). The sensor data can be different for each substrate.

The CIM 101, production dispatcher system 103 manufacturing equipment 112, client device 114, predictive system 116, and data stores 140, 150 can be coupled to each other via network 120. Network 120 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof. The CIM system 101, production dispatcher system 103, and predictive system 116 can be individually hosted or hosted in any combination together by any type of machine including server computers, gateway computers, desktop computers, laptop computers, tablet computers, notebook computers, PDAs (personal digital assistants), mobile communication devices, cell phones, smart phones, hand-held computers, or similar computing devices. In some implementations, predictive system 116 is part of a server that is hosted on a machine.

Data stores 140, 150 can be a memory (e.g., random access memory), a drive (e.g., a hard drive, a flash drive), a database system, or another type of component or device capable of storing data. Data stores 140, 150 can include multiple storage components (e.g., multiple drives or multiple databases) that can span multiple computing devices (e.g., multiple server computers).

Data store 140 can store data associated with processing a substrate at manufacturing equipment 112. For example, data store 140 can store data collected by sensors 126 at manufacturing equipment 112 before, during, or after a substrate process (referred to as process data). Process data can refer to historical process data (e.g., process data generated for a prior substrate processed at the manufacturing system) and/or current process data (e.g., process data generated for a current substrate processed at the manufacturing system). Data store can also store spectral data or non-spectral data associated with a portion of a substrate processed at manufacturing equipment 112. Spectral data can include historical spectral data and/or current spectral data.

Data store 140 can also store contextual data associated with one or more substrates processed at the manufacturing system. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a process chamber.

Data store 140 can also store task data. Task data can include one or more sets of operations to be performed for the substrate during a deposition process and can include one or more settings associated with each operation. For example, task data for a deposition process can include a temperature setting for a process chamber, a pressure setting for a process chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some implementations, data store 140 can be configured to store data that is not accessible to a user of the manufacturing system. For example, process data, spectral data, contextual data, etc. obtained for a substrate being processed at the manufacturing system is not accessible to a user (e.g., an operator) of the manufacturing system. In some implementations, all data stored at data store 140 can be inaccessible by the user of the manufacturing system. In other or similar implementations, a portion of data stored at data store 140 can be inaccessible by the user while another portion of data stored at data store 140 can be accessible by the user. In some implementations, one or more portions of data stored at data store 140 can be encrypted using an encryption mechanism that is unknown to the user (e.g., data is encrypted using a private encryption key). In other or similar implementations, data store 140 can include multiple data stores where data that is inaccessible to the user is stored in one or more first data stores and data that is accessible to the user is stored in one or more second data stores.

Data store 150 dispatching rules 151, state data 153, and user data 155. Dispatching rules 151 can be logic that can be executed by the production dispatcher system 103. In some implementations, dispatching rules 151 can be user (e.g., industrial engineer, process engineer, system engineer, etc.) defined. Examples of dispatching rules 151 can include, and are not limited to, select the highest priority substrate to work on next, select a substrate that uses the same set up which the tool is currently configured for, package items when a purchase order is complete, ship items when packaging is complete, etc. The individual dispatching rules 151 can be associated with a large number of data processes to implement the corresponding dispatching rule 151. Examples of data processes can include, and are not limited to import data, compress data, index data, filter data, perform a mathematical function on data, etc.

State data 153 can include a state of manufacturing equipment 112 (e.g., an operating temperature, an operating pressure, a number of substrates being processed at the manufacturing equipment, a number of substrates in a manufacturing equipment queue at a particular instance of time, current service life, setup data, a set of operations that include individual processes performed at one or more manufacturing facilities of a production environment, etc.). State data 153 can be generated by manufacturing equipment 112 during operation of production environment 100 and stored at data store 150. State data 153 can include one or more of current state data, historical state data, and perturbed state data. Current state data can include data relating to the current state of manufacturing equipment 112 (e.g., current operating temperature, current operating pressure, current number of substrates being processed at the manufacturing equipment, etc.). Historical state data can include data relating to a past state of manufacturing equipment 112 (e.g., past operating temperature at a particular instance of time, past operating pressure at a particular instance of time, past number of substrates being processed at the manufacturing equipment at a particular instance of time, etc.). Perturbed state data can include modified state data. In particular, perturbed state data can include current or historical state data that has had one or more parameters modified or distorted. The one or more parameters can be modified based on user input, a certain percentage, a certain value, randomly modified, etc. For example, perturbed state data can include a past number of substrates being processed at the manufacturing equipment at a particular instance of time reduced or increased by a predetermined value of two substrates. In another example, perturbed state data can include a past number of substrates sets being processed at the manufacturing equipment at a particular instance of time reduced or increased by a random number of sets between, for example, one and ten. In some implementations, state data 153 can include, or be generated from, the data stored in data store 140. For example, state data 153 can include, or be generated from, sensor data, contextual data, task data, etc.

In some implementations, state data can refer to data relating to the environment state of a simulation environment (e.g., environment 204). The environment state data can include manufacturing equipment properties (e.g., step processing times, queue time constraints, etc.), manufacturing equipment observations (e.g., the number of substrates or lots processing per step, the number of lots processing per stations, etc.), queue time observations (e.g., the number of successful lots processed, the number of lots in violation, the number of lots in process, etc.), capacity observations (e.g., an estimation of the time to complete all the work in progress (WIP)). The environment state features can be normalized to values in [0,1] and concatenated into a single observation vector.

User data 155 can include data provided by a user of production environment 100 (e.g., an operator, a process engineer, industrial engineer, system engineer, etc.). In some implementations, user data 155 can be provided via client device 114.

A user device 114 can include a computing device such as a personal computer (PC), laptop, mobile phone, smart phone, tablet computer, netbook computer, network-connected television, etc. In some implementations, user device 114 can provide information to a user (e.g., an operator, an industrial engineer, a process engineer, a system engineer, etc.) of production environment 100 via one or more graphical user interfaces (GUIs).

Examples of CIM systems 101 can include, and are not limited to, a manufacturing execution system (MES), enterprise resource planning (ERP), production planning and control (PPC), computer-aided systems (e.g., design, engineering, manufacturing, processing planning, quality assurance), computer numerical controlled machine tools, direct numerical control machine tools, controllers, etc.

In some implementations, predictive system 116 includes predictive server 118 and server machine 180. The predictive server 118 and server machine 180 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Predictive system 116 can train software agent 190 (e.g., an intelligent agent). A software agent is a computer program that acts for a user or other program in a relationship of agency. In some implementations, software agent 190 can be trained using reinforcement learning, deep reinforcement learning, etc. Reinforcement learning is a class of algorithms applicable to sequential decision-making tasks. In particular, reinforcement learning is a process in which a software agent learns to make decisions through trial and error.

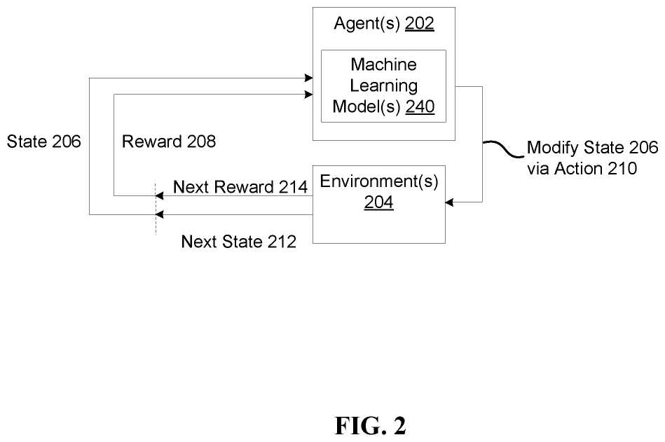

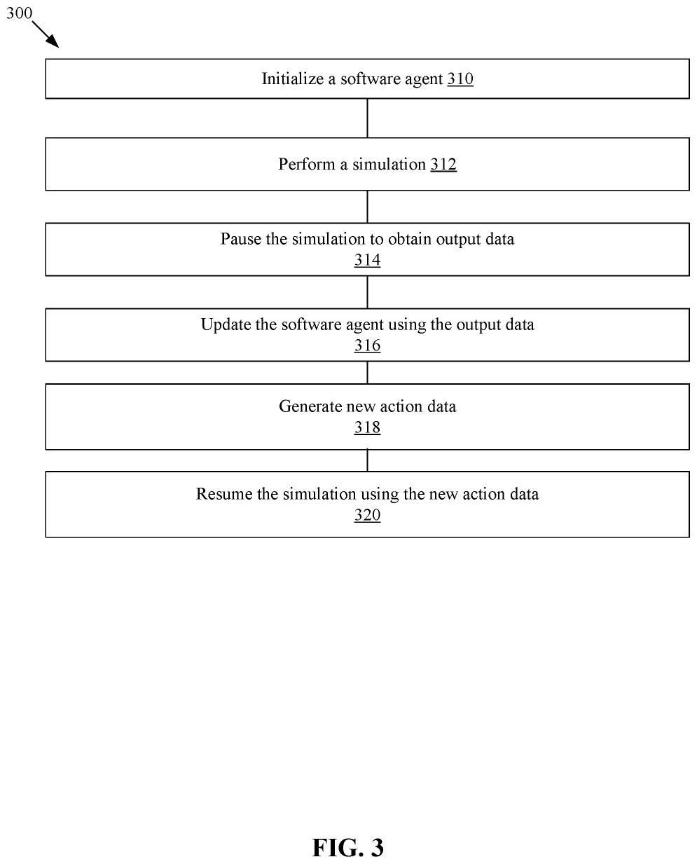

In some implementations, training the software agent can include using deep reinforcement learning. Deep reinforcement learning combines artificial neural networks with a framework of reinforcement learning that helps software agents learn how to reach their goals. In particular, deep reinforcement learning unites function approximation and target optimization, mapping states and actions to the rewards they lead to. Deep reinforcement learning includes learning from existing knowledge and applying it to a new data set whereas reinforcement learning can include dynamically learning with a trial and error method to maximize the outcome. In an implementation, the Proximal Policy Optimization (PPO) algorithm can be used to train software agent 190. The PPO algorithm is a deep RL algorithm which uses a policy gradient method to train a stochastic policy in an on-policy way. The PPO algorithm also utilizes the actor critic method. Details regarding training software agent 190 using deep reinforcement learning are described below in FIGS. 2 and 3.

Deep learning is a class of machine-learning algorithms that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

In some implementations, training of a neural network can be achieved using reinforcement learning. Reinforcement learning differs from supervised learning in not needing labelled input/output pairs be presented, and in not needing sub-optimal actions to be explicitly corrected. The focus of reinforcement learning can be on finding a balance between exploration of uncharted territory and exploitation of current knowledge. Partially supervised reinforcement algorithms can combine the advantages of supervised and RL algorithms.

Server machine 180 can include a training engine 182. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 can be capable of training one or more software agents 190. Software agent 190 can be created by the training engine 182 using the training data (also referred to herein as a training set) that includes simulation environments, rewards, actions, states (e.g., observations), etc.

To effectuate training, processing logic can input the training dataset(s) into one or more simulation environments. Prior to inputting a first input into the simulation environment, the software agent can be initialized. Processing logic trains the software agent based on the actions provided to the simulation environment and the rewards and observations obtained from the simulation environment (based on the simulation state). Processing logic can pause the simulation and the software agent processes the obtained observations (e.g., state data) and rewards data and selects a new action to input into the simulation. The simulation then resumes and this can be repeatedly performed until the simulations is complete. The software agent can be trained on multiple simulations. Once trained, the software agent can be applied to current state data of the manufacturing equipment, and generate an output indicative of one or more predictions or inferences. For example, an output prediction or inference can include whether or not a certain candidate set of substrates can start a time-sensitive constraint within a predetermined amount of time (e.g., the next 15 minutes), when to release one or more substrates for processing, etc.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one implementation, the stopping criteria is met when at least a minimum number of data points have been processed and at least a threshold accuracy is achieved. The threshold accuracy can be, for example, 70%, 80% or 90% accuracy. In one implementation, the stopping criterion is met if accuracy of the machine-learning model has stopped improving. If the stopping criterion has not been met, further training is performed. If the stopping criterion has been met, training can be complete. Once the machine-learning model is trained, a reserved portion of the training dataset can be used to test the model.

Once one or more trained software agents 190 are generated, they can be stored in predictive server 118 as predictive component 119 or as a component of predictive component 119.

As described in detail below, predictive server 118 includes a predictive component 119 that is capable of running trained software agent 190 on current state data and providing predicative data indicative of when to release one or more substrates for processing, the number of substrates at manufacturing system that can be successfully processed according to a set of operations having one or more time constraints, etc. This will be explained in further detail below.

It should be noted that in some other implementations, the functions of server machine 180, as well as predictive server 118, can be provided by a fewer number of machines. For example, in some implementations, server machine 180 and predictive server 118, can be integrated into a single machine.

In general, functions described in one implementation as being performed by server machine 180 and/or predictive server 118 can also be performed on client device 114. In addition, the functionality attributed to a particular component can be performed by different or multiple components operating together

In implementations, a “user” can be represented as a single individual. However, other implementations of the disclosure encompass a “user” being an entity controlled by a plurality of users and/or an automated source. For example, a set of individual users federated as a group of administrators can be considered a “user.”

The production dispatcher system 103 can make dispatching decisions for the production environment 100. A dispatching decision decides what action should be performed at a given time in the production environment 100. Dispatching often involves decisions such as whether the start processing a batch, whether to start processing a batch that has fewer substrates than allowed or wait to start the batch until additional substrates are available so a full batch can be started, etc. Examples of dispatching decisions can include, and are not limited to, where a substrate should be processed next in the production environment, which substrate should be picked for an idle piece of equipment in the production environment, and so forth. In some implementations, the production dispatcher system 103 can use the predictive data generated by the predictive component 119 to make a dispatching decision. In some implementations, the production dispatcher system 103 can use one or more dispatching rules 151 that are stored in the data store 150 to make a dispatching decision.

In some instances, manufacturing processes can include of hundreds of operations performed by manufacturing equipment 112 (e.g., tools or automated devices) within the production environment 100. In many instances, one or more operations can be subjected to a time constraint. As discussed previously, a time constraint refers to a particular amount of time after an operation is completed that a subsequent operation is to be completed. For example, after a first material is deposited on a surface of a substrate, a second material is to be deposited on the first material within a particular amount of time after the deposition of the first material. If the second coating is not deposited on the first material within the particular amount of time, the first material can begin to degrade, leaving the substrate unusable. A time constraint window refers to an amount of time to complete a first operation (referred to as an initiating operation) and the particular amount of time a second operation (referred to as a completion operation) is to be completed. In some implementations, one or more operations performed between the initiating operation and the completion operation are also associated with the time constraint window. In accordance with the previous example, a time constraint window can refer to a first amount of time to deposit the first material on the surface of the substrate and the particular amount of time in which the second material is to be deposited on the first material. Multiple operations can be subject to one or more time constraints. In some implementations, a completion operation for a first time constraint window can also be an initiating operation for a second time constraint window.

FIG. 2 illustrates an example system 200 for performing reinforcement learning to generate a software agent, according to certain implementations of the present disclosure. Example system 200 includes software agent 202 and simulation environment 204 (e.g., a simulator). Agent 202 takes actions that affect environment 204 and change its state (e.g., the environment state). The environment state is a representation of the current environment that the agent is in. This state can be observed by agent 202, and it includes all relevant information about the environment that agent 202 needs to know in order to make a decision (e.g., perform an action). Following each action, agent 202 transitions to the next environment state and receives a reward.

Agent 202 can use one or more machine learning models 240. The machine learning model 240 may be, for example a deep neural network (e.g., a convolutional neural network, transformer, graph neural network etc.) or decision trees. Machine learning model 240 can represent a policy (e.g., a solution policy). The policy can be a strategy of actions that promises the highest long-term reward.

Agent 202 can be rewarded for taking controls that lead to successful environment states. The rewards can be immediate, such as receiving a point for each step taken in the right direction, or they can be delayed, such as receiving a point at the end of the episode if the goal was reached. An episode can refer to a sequence of environment states, actions and rewards, which ends with terminal environment state. In an illustrative example, each episode (or experiment) can include 100 timesteps, and each timestep can take 100 minutes. At each timestep, agent 202 can take a single action. Following the action, agent 202 receive an observation (e.g., environment state data) reflecting the state of environment 204 at the end of the timestep. An episode terminates when 100 timesteps have passed, or, for example when a predetermine number of lots (e.g., 10 lots) complete the route, whichever happens first.

In some implementations, example system 200 uses the Markov Decision Process (MDP) formalism wherein agent 202 attempts to optimize a function in its environment 204. An MDP can be described by an environment state space S (with states s E S), a action space A (a∈A), a transition function T: S×A→S and a reward function R: S×A→ [symbol] . In an MDP, an episode evolves over discrete time steps t=0, 1, 2, . . . , n, where the agent 202 observes an environment state sₜ (206) and responds with an action at (210) using a policy π(aₜ|sₜ). The environment 204 provides to the agent 202 the next environment state sₜ₊₁˜T(sₜ, aₜ) 212 and the reward rₜ=R(sₜ, aₜ) 214. The agent 202 is tasked with maximizing the return (cumulative future rewards) by learning an optimal policy π*.

In some implementations, queue time management can be modeled as a discrete-time, finite-horizon MDP which is a tuple M=(S, A, P, R, ρ⁰, T), where S is a environment state set, A an action set, P: S×A×S→R+ a transition probability distribution, R: S×A→R a reward function, ρ⁰: S→[0, 1] an initial environment state distribution, and T the time horizon. A solution policy can be a probability distribution π: S×A→[0,1] that maps environment states to actions. To find a solution policy, agent 202 can be trained to learn a policy which maximizes the expected return E_{τ}Σₜ₋₀^{T}R(s^{t}, a^{t}) where τ:=(s⁰, a⁰, s¹, a¹ . . . ) denotes a trajectory, s⁰˜ρ⁰, a^{t}˜π(s^{t}), s^{t+1}˜P(s^{t}, a^{t}).

During training, agent 202 takes an action. Environment 204 applies that action and simulates one timestep into the future. Agent 202 then receives new environment state data and a new reward. The state-action-reward sequence is stored, and periodically, the reinforcement learning algorithm uses this experience to update the weights of the neural network (e.g., machine learning model 240) which represents the policy. The policy is used to pick the next action. The policy updates aim to maximize the cumulative reward over the time horizon. Once the learning curve stabilizes and the policy stops improving, processing logic (e.g., training engine 182) can store the policy and use it to test the performance of software agent 202 on one or more of environments.

Environment state data (e.g., data relating to the state of environment 204) can include manufacturing equipment properties (e.g., step processing times, queue time constraints, etc.), manufacturing equipment observations (e.g., the number of substrates or lots processing per step, the number of lots processing per stations, etc.), queue time observations (e.g., the number of successful lots processed, the number of lots in violation, the number of lots in process, etc.), capacity observations (e.g., an estimation of the time to complete all the work in progress (WIP)), quantities of lots or substrates waiting to process various steps and/or waiting to start various time constraints, etc. The state features can be normalized to values in [0,1] and concatenated into a single observation vector.

At each time step, agent 202 can decide either to release or not to release a lot. Agent 202 can release a lot of one of the N part types (or lots waiting for a processing step or gate step). Thus, agent 202 can choose a discrete action between 0 to N. Choosing an action 0 does not release any lots and action aᵢ releases a lot of type Partᵢ. Agent 202 can also choose an action involving releasing multiple lots, potentially of different part types or steps.

The reward structure can be configured such that it encourages agent 202 to minimize the number of queue time violations while optimizing for makespan (e.g., the time difference between the start and finish of a sequence of jobs or tasks), and the number of successful lots. The reward structed can also be configured such that it encourages agent 202 to maximize the throughput of the manufacturing equipment.

FIG. 3 is a flow chart of a method 300 for training a software agent, according to aspects of the present disclosure. Method 300 is performed by processing logic that can include hardware (circuitry, dedicated logic, etc.), software (such as is run on a general purpose computer system or a dedicated machine), firmware, or some combination thereof. In one implementation, method 300 can be performed by a computer system, such as computer system architecture 100 of FIG. 1. In other or similar implementations, one or more operations of method 300 can be performed by one or more other machines not depicted in the figures. In some aspects, one or more operations of method 300 can be performed by server machine 180 and/or predictive server 118.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 310, processing logic initializes a software agent. In some implementations, the software agent can have access to environment state data and or state data (e.g., data associated with operations related to the fabrication of semiconductor substrates, such as historic state data, current state data, perturbed state data, etc).

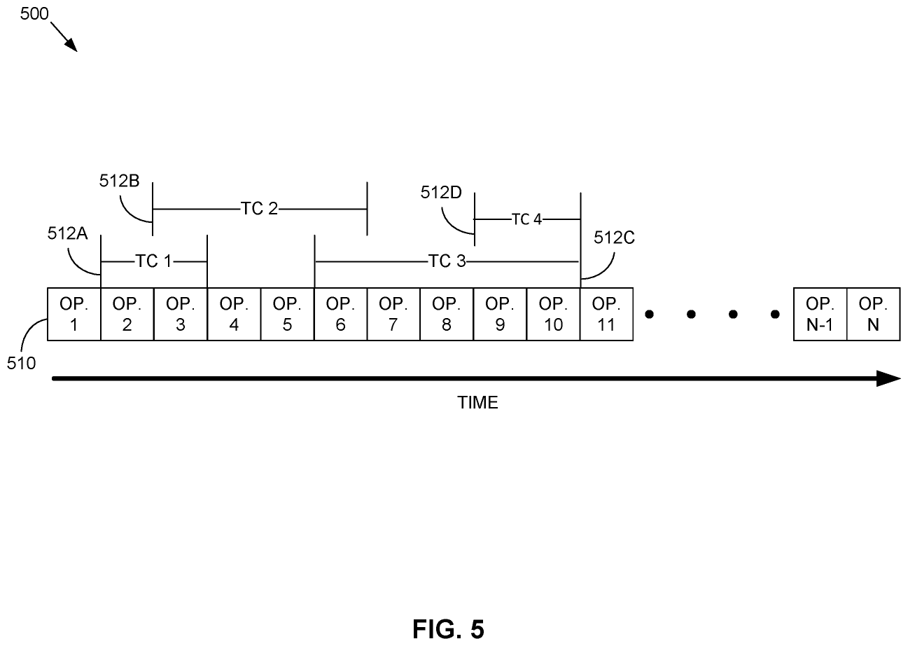

At operation 312, processing logic performs one or more of simulations. The one or more simulations can be performed in a simulation environment (e.g., environment 204). In some implementations, a simulation can include simulating an action (e.g., one timestep into the future). In some implementations, processing logic can determine a particular time period the training set of operations are to be run at the manufacturing system. In some implementations, the training set of operations can be the set of operations illustrated by FIG. 5. The particular time period can be a simulation condition, in accordance with previously described implementations.

In some implementations, the simulation can be performed in response to the software agent selecting action data. Action data can include a set of possible moves, actions, or operations the software agent can make. In some implementations, an action can include not releasing a lot, releasing a specific lot, releasing a lot for a specific process chamber, releasing a lot during a certain time period, etc. In some implementations, the action can include determining a training set of substrates to be processed during a training set of operations. The training set of candidate substrates and the training set of operations be determined using the state data, operator input, a predetermined set of rules (e.g., one or more predetermined sets of substrates, one or more predetermined sets of operations, etc.), random input, or any combination thereof.

At operation 314, processing logic pauses the simulation to obtain output data. In some implementations, the output data can include new environment state data and reward data based on the current environment state.

At operation 316, processing logic updates the software agent based on the output data (e.g., new environment state data and new reward data). The new reward data can include feedback data by which the success or failure of an action in a given state is measured.

At operation 318, processing logic generates, by the software agent, a new action (e.g., action data) data based on the new state data.

At operation 320, processing logic resumes the simulation using the new action data. For example, the processing logic can simulate the new action in the environment.

The processing logic can perform operations 312 through 316 until the simulation or the set of simulations is complete. The processing logic can perform operation 300 until training the software agent is complete. In some implementations, the output data indicates a number of candidate substrates that were successfully processed during each of the simulated set of operations to reach the end of the time period.

It should be noted that in some implementations, the sufficiency of training can be determined based simply on the amount of training data or updates to the software agent, while in some other implementations, the sufficiency of training can be determined based on one or more other criteria (e.g., a measure of diversity of the training examples, etc.).

After operation 318, the software agent can be used to generate predictive data (e.g., dispatching decisions) based on current state data. In some implementations, the predictive data can include one or more dispatching decisions. For example, the machine-learning model can receive, as input, current state data and output the dispatching decision(s). As discussed above, a dispatching decision decides what action should be performed at a given time in the production environment 100. Dispatching can involve decisions such as whether to start processing a batch that has fewer substrates than allowed, or wait to start the batch until additional substrates are available so a full batch can be started. Examples of dispatching decisions can include, and are not limited to, where a substrate should be processed next in the production environment, which substrate should be picked for an idle piece of equipment in the production environment, and so forth.

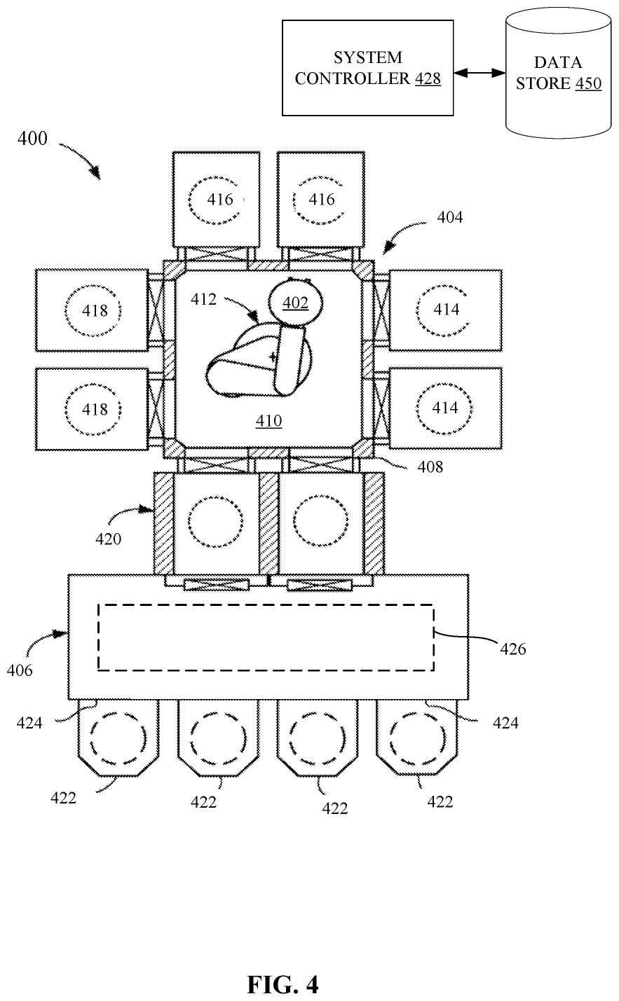

FIG. 4 is a top schematic view of an example manufacturing system 400, according to aspects of the present disclosure. Manufacturing system 400 can perform one or more processes on a substrate 402. Substrate 402 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 400 can include a process tool 404 and a factory interface 406 coupled to process tool 404. Process tool 404 can include a housing 408 having a transfer chamber 410 therein. Transfer chamber 410 can include one or more process chambers (also referred to as processing chambers) 414, 416, 418 disposed therearound and coupled thereto. Process chambers 414, 416, 418 can be coupled to transfer chamber 410 through respective ports, such as slit valves or the like. Transfer chamber 410 can also include a transfer chamber robot 412 configured to transfer substrate 402 between process chambers 414, 416, 418, load lock 420, etc. Transfer chamber robot 412 can include one or multiple arms where each arm includes one or more end effectors at the end of each arm. The end effector can be configured to handle particular objects, such as wafers, sensor discs, sensor tools, etc.

Process chambers 414, 416, 418 can be adapted to carry out any number of processes on substrates 402. A same or different substrate process can take place in each processing chamber 414, 416, 418. A substrate process can include atomic layer deposition (ALD), physical vapor deposition (PVD), chemical vapor deposition (CVD), etching, annealing, curing, pre-cleaning, metal or metal oxide removal, or the like. Other processes can be carried out on substrates therein. Process chambers 414, 416, 418 can each include one or more sensors configured to capture data for substrate 402 before, after, or during a substrate process. For example, the one or more sensors can be configured to capture spectral data and/or non-spectral data for a portion of substrate 402 during a substrate process. In other or similar implementations, the one or more sensors can be configured to capture data associated with the environment within process chamber 414, 416, 418 before, after, or during the substrate process. For example, the one or more sensors can be configured to capture data associated with a temperature, a pressure, a gas concentration, etc. of the environment within process chamber 414, 416, 418 during the substrate process.

A load lock 420 can also be coupled to housing 408 and transfer chamber 410. Load lock 420 can be configured to interface with, and be coupled to, transfer chamber 410 on one side and factory interface 406. Load lock 420 can have an environmentally-controlled atmosphere that can be changed from a vacuum environment (wherein substrates can be transferred to and from transfer chamber 410) to at or near atmospheric-pressure inert-gas environment (wherein substrates can be transferred to and from factory interface 406) in some implementations. Factory interface 406 can be any suitable enclosure, such as, e.g., an Equipment Front End Module (EFEM). Factory interface 406 can be configured to receive substrates 402 from substrate carriers 422 (e.g., Front Opening Unified Pods (FOUPs)) docked at various load ports 424 of factory interface 406. A factory interface robot 426 (shown dotted) can be configured to transfer substrates 402 between carriers (also referred to as containers) 422 and load lock 420. Carriers 422 can be a substrate storage carrier or a replacement part storage carrier.

Manufacturing system 400 can also be connected to a client device (not shown) that is configured to provide information regarding manufacturing system 400 to a user (e.g., an operator). In some implementations, the client device can provide information to a user of manufacturing system 400 via one or more graphical user interfaces (GUIs). For example, the client device can provide information regarding a target thickness profile for a film to be deposited on a surface of a substrate 402 during a deposition process performed at a process chamber 414, 416, 418 via a GUI. The client device can also provide information regarding a modification to a process recipe in view of a respective set of deposition settings predicted to correspond to the target profile, in accordance with implementations described herein.

Manufacturing system 400 can also include a system controller 428. System controller 428 can be and/or include a computing device such as a personal computer, a server computer, a programmable logic controller (PLC), a microcontroller, and so on. System controller 428 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 428 can include a data storage device (e.g., one or more disk drives and/or solid state drives), a main memory, a static memory, a network interface, and/or other components. System controller 428 can execute instructions to perform any one or more of the methodologies and/or implementations described herein. In some implementations, system controller 428 can execute instructions to perform one or more operations at manufacturing system 400 in accordance with a process recipe. The instructions can be stored on a computer readable storage medium, which can include the main memory, static memory, secondary storage and/or processing device (during execution of the instructions).

System controller 428 can receive data from sensors included on or within various portions of manufacturing system 400 (e.g., processing chambers 414, 416, 418, transfer chamber 410, load lock 420, etc.). In some implementations, data received by the system controller 428 can include spectral data and/or non-spectral data for a portion of substrate 402. In other or similar implementations, data received by the system controller 428 can include data associated with processing substrate 402 at processing chamber 414, 416, 418, as described previously. For purposes of the present description, system controller 428 is described as receiving data from sensors included within process chambers 414, 416, 418. However, system controller 428 can receive data from any portion of manufacturing system 400 and can use data received from the portion in accordance with implementations described herein. In an illustrative example, system controller 428 can receive data from one or more sensors for process chamber 414, 416, 418 before, after, or during a substrate process at the process chamber 414, 416, 418. Data received from sensors of the various portions of manufacturing system 400 can be stored in a data store 450. Data store 450 can be included as a component within system controller 428 or can be a separate component from system controller 428. In some implementations, data store 450 can be data store 140, 150 described with respect to FIG. 1.

FIG. 5 illustrates a set of operations 500 subject to one or more time constraints, according to implementations of the present disclosure. Each operation 510 of the training set of operations can correspond to an individual process performed at one or more manufacturing facilities of a production environment, such as manufacturing equipment 112 (e.g., a tool or automated device) of production environment 100. In some implementations, each of the set of operations 500 can be consecutive operation (e.g., each operation 510 is performed in accordance with a particular ordering). In some implementations, each operation 510 can correspond to an individual process performed at a front-end manufacturing facility, including, but not limited to, photolithography, deposition, etching, cleaning, ion implantation, chemical and mechanical polishing, etc. In other or similar implementations, each operation can correspond to an individual process performed at a back-end manufacturing facility, including, but not limited to, dicing a completed wafer into individual semiconductor die, testing, assembly, packaging, etc.

As described previously, one or more operations 510 can be subjected to a time constraint. For example, operation 2 can be a first deposition operation to deposit a first material on a surface of a substrate and operation 3 can be a second deposition operation to deposit a second material on the first material. Operations 2 and 3 can be subject to a first time constraint where the second material is to be deposited on the first material within a particular amount of time (e.g., 6 hours) after deposition of the first material on the surface of the substrate. An amount of time for manufacturing equipment 112 to perform operations 2 and 3 can correspond to a time constraint window 512. The time constraint window 512 can include a first amount of time to complete an initiating operation (i.e., an operation 510 that initiates a time constraint window 512) and the particular amount of time in which manufacturing equipment 112 is to complete a completion operation (i.e., an operation 510 that completes the time constraint window 512). In accordance with the previous example, operation 2 is to be started for a substrate at manufacturing equipment 112 so that operations 2 and 3 will be completed for the substrate within a first time constraint window 512A.

In some implementations, a completion operation of a time constraint window 512 can be an initiating operation for another time constraint window 512. For example, operation 3 can be a second deposition operation and operation 6 can be an etching operation. Operations 3, 4, 5, and 6 can be subject to a time constraint where the second material is to be etched at operation 6 within a particular amount of time (e.g., 12 hours) after deposition of the second material at operation 3. A second time constraint window 512B can include an amount of time to deposit the second material at operation 3 and the particular amount of time to complete operation 6. Operation 3 is to be started at manufacturing equipment 112 so that operations 3, 4, 5, and 6 will be completed within the second time constraint window 512B. In accordance with the previous example, operation 3 can be subject to a time constraint with operation 2. As such, operation 2 is to be started for a substrate so that operations 2 and 3 will be completed for the substrate within the first time constraint window 512A and that operations 3, 4, 5, and 6 will be completed within the second time constraint window 512B. The first time constraint window 512A and the second time constraint window 512B together are referred to a cascading time constraint window.

In some implementations, an operation 510 can be subject to more than one time constraint. For example, operations 6, 7, 8, 9, and 10 can be subject to a first time constraint where operation 10 is to be completed within a particular amount of time after operation 6 is completed. A third time constraint window 512C can include an amount of time to perform operation 6 and the particular amount of time to complete operation 10. Operations 9 and 10 can also be subject to a second time constraint where operation 10 is to be completed within a particular amount of time after operation 9 is completed. A fourth time constraint window 512D can include an amount of time to complete operation 9 and the particular amount of time to complete operation 10. As such, operation 6 is to be started so that operations 6, 7, 8, 9, and 10 will be completed within the third time constraint window 512D and operations 9 and 10 will be completed within the fourth time constraint window. The third time constraint window 512C and the fourth time constraint window 512 together are referred to a nested time constraint window.

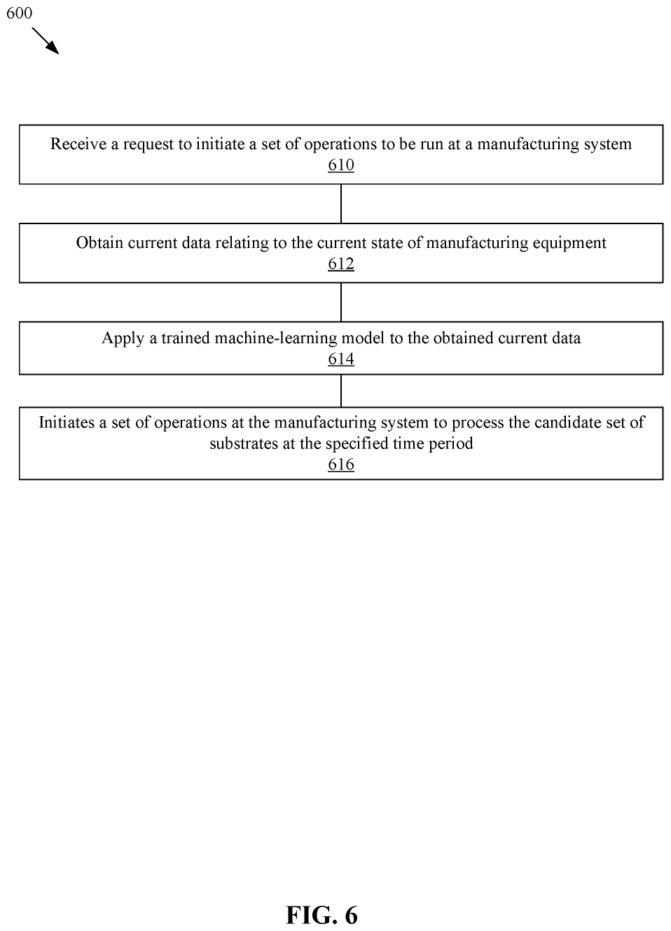

FIG. 6 is a flow chart of a method 600 for initiating a set of operations based on the dispatching decisions generated using the software agent, according to aspects of the present disclosure. Method 600 is performed by processing logic that can include hardware (circuitry, dedicated logic, etc.), software (such as is run on a general purpose computer system or a dedicated machine), firmware, or some combination thereof. In one implementation, method 600 can be performed by a computer system, such as computer system architecture 100 of FIG. 1. In other or similar implementations, one or more operations of method 600 can be performed by one or more other machines not depicted in the figures. In some aspects, one or more operations of method 600 can be performed by server machine 180, predictive server 118, CIM system 101, and/or production dispatcher system 103.

At operation 610, the processing logic receives a request to initiate a set of operations to be run at a manufacturing system. In some implementations, the manufacturing system can be production environment 100 of FIG. 1. In some implementations, the request can be a request to initiate the set of operations to be run at the manufacturing system at a particular instance in time. For example, the request can be a request to initiate the set of operations at 8:00 p.m. In some implementations, the request can be a request to initiate the set of operations on a candidate set of substrates. In some implementations, the request can be a request for a dispatching decision(s) relating to the candidate set of substrates. For example, the request can request a next available time to initiate the set of operations on the candidate set of substrates where no time constraint issues will occur.

At operation 612, the processing logic obtains current data relating to the current state of manufacturing equipment. In some implementations, the current data can include current state data, sensor data, contextual data, task data, etc. In some implementations, the current data can include a number of substrates being processed at the manufacturing equipment at a particular instance of time, a number of substrates in a manufacturing equipment queue, current service life, setup data, a set of operations that include individual processes performed at one or more manufacturing facilities of a production environment, etc. In some implementations, the current data can relate to one or more operations being performed on one or more substrates being processed. For example, the operation can include a deposition process performed in a process chamber to deposit one or more layers of film on a surface of a substrate, an etch process performed on the one or more layers of film on the surface of the substrate, etc. The operation can be performed according to a recipe. The sensor data can include a value of one or more of temperature (e.g., heater temperature), spacing, pressure, high frequency radio frequency, voltage of electrostatic chuck, electrical current, material flow, power, voltage, etc. Sensor data can be associated with or indicative of manufacturing parameters such as hardware parameters, such as settings or components (e.g., size, type, etc.) of the manufacturing equipment 112, or process parameters of the manufacturing equipment 112.

At operation 614, the processing logic applies a software agent (e.g., agent 190) to the obtained current data. The software agent can be used to generate predictive data that includes one or more dispatching decisions.

At operation 616, the processing logic initiates a set of operations at the manufacturing system to process the candidate set of substrates at the specified time period.

In some implementations predictive data that includes one or more dispatching decisions. A dispatching decision decides what action should be performed at a given time in the production environment 100. In some implementations, the dispatching decision can include a candidate set of substrates and a specified time period. The software agent can generate the predicative data.

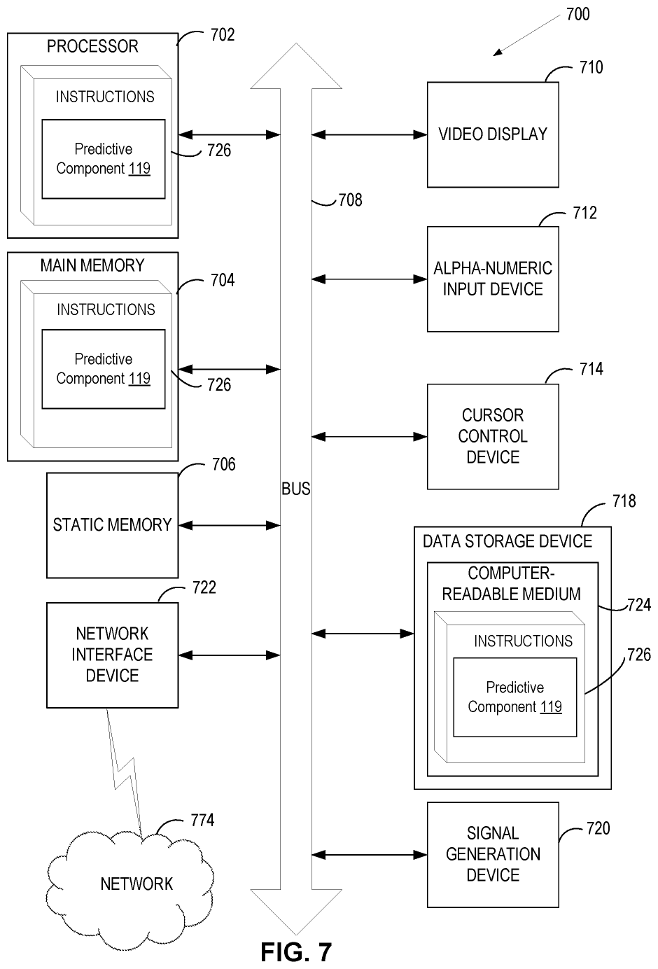

FIG. 7 is a block diagram illustrating a computer system 700, according to certain implementations. In some implementations, computer system 700 can be connected (e.g., via a network, such as a Local Area Network (LAN), an intranet, an extranet, or the Internet) to other computer systems. Computer system 700 can operate in the capacity of a server or a client computer in a client-server environment, or as a peer computer in a peer-to-peer or distributed network environment. Computer system 700 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 can include a processing device 702, a volatile memory 704 (e.g., Random Access Memory (RAM)), a non-volatile memory 706 (e.g., Read-Only Memory (ROM) or Electrically-Erasable Programmable ROM (EEPROM)), and a data storage device 716, which can communicate with each other via a bus 708.

Processing device 702 can be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 700 can further include a network interface device 722 (e.g., coupled to network 774). Computer system 700 also can include a video display unit 710 (e.g., an LCD), an alphanumeric input device 712 (e.g., a keyboard), a cursor control device 714 (e.g., a mouse), and a signal generation device 720.

In some implementations, data storage device 716 can include a non-transitory computer-readable storage medium 724 on which can store instructions 726 encoding any one or more of the methods or functions described herein, including instructions encoding components of FIG. 1 (e.g., predictive component 119, time constraint simulation module 107, etc.) and for implementing methods described herein.

Instructions 726 can also reside, completely or partially, within volatile memory 704 and/or within processing device 702 during execution thereof by computer system 700, hence, volatile memory 704 and processing device 702 can also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and can not have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method, comprising:
initializing, by a processor, an agent of a predictive subsystem of a substrate manufacturing system to select an action to perform in a simulation environment associated with the substrate manufacturing system;
initiating a simulation of the selected action in the simulation environment;
in response to pausing the simulation, obtaining, based on an environment state associated with the simulation, output data; and
updating the agent, based on the output data, to be configured to generate one or more dispatching decisions indicative of a time to initiate processing of one or more substrates in the substrate manufacturing system.

2. The method of claim 1, further comprising:
receiving a request to initiate a set of operations to be run on a candidate set of substrates at the substrate manufacturing system, wherein the set of operations comprises one or more operations that each have one or more time constraints;
obtaining current data relating to a current state of the substrate manufacturing system;
providing the current data as input to the agent to obtain one or more outputs indicating a time to process the candidate set of substrates; and
initiating the set of operations on the candidate set of substrates at the determined time.

3. The method of claim 1, further comprising:
receiving a request to initiate a set of operations to be run on a candidate set of substrates at the substrate manufacturing system, wherein the set of operations comprises one or more operations that each have one or more time constraints;
obtaining current data relating to a current state of the substrate manufacturing system;
providing the current data as input to the agent to obtain one or more outputs indicating a subset of substrates to process from a candidate set of substrates; and
initiating the set of operations on the subset of substrates.

4. The method of claim 1, wherein the agent comprises a deep reinforcement learning model.

5. The method of claim 1, further comprising:
selecting a new action based on the output data; and
initiating the simulation of the new action in the simulation environment.

6. The method of claim 1, wherein the output data comprises environment state data and reward data, wherein the environment state data comprises at least one of manufacturing equipment properties, manufacturing equipment observations, queue time observations, or capacity observations.

7. The method of claim 1, wherein the action comprises a decision to at least one of initiate processing of one or more substrates, not initiate processing of the one or more substrates, or initiate processing of a subset of the one or more substrates.

8. An electronic device manufacturing system, comprising:
a memory device; and
a processing device, operatively coupled to the memory device, to perform operations comprising:
initializing an agent of a predictive subsystem of the manufacturing system to select an action to perform in a simulation environment associated with the manufacturing system;
initiating a simulation of the selected action in the simulation environment;
in response to pausing the simulation, obtaining, based on an environment state associated with the simulation, output data; and
updating the agent, based on the output data, to be configured to generate one or more dispatching decisions indicative of a time to initiate processing of one or more substates in the manufacturing system.

9. The electronic device manufacturing system of claim 8, wherein the operations further comprise:
receiving a request to initiate a set of operations to be run one a candidate set of substrates at the manufacturing system, wherein the set of operations comprises one or more operations that each have one or more time constraints;
obtaining current data relating to a current state of the manufacturing system;
providing the current data as input to the agent to obtain one or more outputs indicating a time to process the candidate set of substrates; and
initiating the set of operations on the candidate set of substrates at the determined time.

10. The electronic device manufacturing system of claim 8, wherein the operations further comprise:
receiving a request to initiate a set of operations to be run one a candidate set of substrates at the manufacturing system, wherein the set of operations comprises one or more operations that each have one or more time constraints;
obtaining current data relating to a current state of the manufacturing system;
providing the current data as input to the agent to obtain one or more outputs indicating a subset of substrates to process from a candidate set of substrates; and
initiating the set of operations on the subset of substrates.

11. The electronic device manufacturing system of claim 8, wherein the agent comprises a deep reinforcement learning model.

12. The electronic device manufacturing system of claim 8, wherein the operations further comprise:
selecting a new action based on the output data; and
initiating the simulation of the new action in the simulation environment.

13. The electronic device manufacturing system of claim 8, wherein the output data comprises environment state data and reward data, wherein the environment state data comprises at least one of manufacturing equipment properties, manufacturing equipment observations, queue time observations, or capacity observations.

14. The electronic device manufacturing system of claim 8, wherein the action comprises a decision to at least one of initiate processing of one or more substrates, not initiate processing of the one or more substrates, or initiate processing of a subset of the one or more substrates.

15. A method, comprising:
receiving a request to initiate a set of operations to be run one a candidate set of substrates at a substrate manufacturing system, wherein the set of operations comprises one or more operations that each have one or more time constraints;
obtaining current data relating to a current state of the substrate manufacturing system;
providing the current data as input to the agent to obtain one or more outputs indicating a time to process the candidate set of substrates; and
initiating the set of operations on at least one of the candidate set of substrates at the determined time or the subset of substrates.

16. The method of claim 15, wherein training the agent comprises:
initializing the agent to select an action to perform in a simulation environment associated with the substrate manufacturing system;
initiating a simulation of the selected action in the simulation environment;
in response to pausing the simulation, obtaining, based on an environment state associated with the simulation, output data; and
updating the agent, based on the output data, to be configured to generate one or more dispatching decisions indicative of a time to initiate processing of one or more substrates in the substrate manufacturing system.

17. The method of claim 15, wherein the agent comprises a deep reinforcement learning model.

18. The method of claim 15, wherein the output data comprises environment state data and reward data.

19. The method of claim 18, wherein the environment state data comprises at least one of manufacturing equipment properties, manufacturing equipment observations, queue time observations, or capacity observations.

20. The method of claim 15, wherein the action comprises a decision to at least one of initiate processing of one or more substrates, not initiate processing of the one or more substrates, or initiate processing of a subset of the one or more substrates.
